(19) United States
(12) Patent Application Publication
(10) Pub. No.: US 2008/0276037 A1
(43) Pub. Date: Nov. 6, 2008

(54) Method to Access Storage Device Through Universal Serial Bus

(75) Inventors: Chi-Tung Chang, Taipei City (TW); Ching-Wen Wang, Taipei County (TW)

Correspondence Address: HOFFMANN & BARON, LLP, 6900 JERICHO TURNPIKE, SYOSSET, NY, 11791, US

(73) Assignee: ALCOR MICRO, CORP., Taipei (TW)

(21) Appl. No.: 12/172,672

(22) Filed: Jul. 14, 2008

Related U.S. Application Data
(63) Continuation of application No. 11/447,571, filed on Jun. 6, 2006.

(51) Int. Cl. G06F 12/02

(52) U.S. Cl. 711/103; 711/E12.008

(57) ABSTRACT

A method accessing a flash memory storage device through universal serial bus (USB) of the present invention includes a flash controller and a flash memory, wherein the method includes connecting the storage device to a USB interface of an electronic device; outputting a plurality of accessing instructions to the flash controller via the electronic device; deciding which data is needed to be temporarily saved in a cache memory and a priority of the accessing instructions according to the characteristic of the file system and the content of preceding instructions of the flash controller; and writing the data temporarily saved in the cache memory into the flash memory according to the priority of the flash controller. The objective of the method of the present invention is to enhance the operation efficiency of the storage device.

This application is a continuation-in-part of pending U.S. patent application Ser. No. 11/447,571 filed on Jun. 6, 2006.

### BACKGROUND OF THE INVENTION

1. Field of the Invention

The present invention relates to a method of accessing to a flash memory storage device, and more particularly to a method of accessing to a flash memory storage device through a universal serial bus (USB).

2. Description of the Related Art

The high development in electronic technology, the demand of the consumers in the portable storage device is increasing. The capacity of the portable storage device has become larger and larger, and the size of the portable storage device has become smaller and smaller. It is to be noted that the present-day market of portable flash memory storage device using universal serial bus (USB) interface has been growing rapidly.

In the conventional method for accessing to a storage device via the flash memory, the data have to be moved repeatedly into and from a flash which is usually provided in the storage device in such that the data can be accessed by the flash controller of the storage device. The requirement of repeating moving data is time-consuming, particularly when all read/write instructions have to be executed without being filtered according to a priority strategy. Therefore, the operation efficiency of the conventional flash memory storage device is seriously limited.

In conventional storage device technique, the flash memory has been used as the data storage region. However, the characteristic of the conventional flash memory utilization is that the instructions and data are needed to be written and read in accordance with the instructions and data length. That means, all the instructions and data have to at least be moved with the basic block unit, even when the wanted transferring instructions and data section is fewer than basic block unit. This process also happens when the user wishes to update any information deposited in flash memory. The movement of transferring excess instructions and data length than the actually necessary data length is called “copyback”. The movement of copyback costs extra time consumption due to the additionally unnecessary data transferring. Further, the time consumption of the unnecessary data transferring requires more time than the requested data movement itself. Therefore, the operational efficiency of flash memory has been diminished since the overwhelmingly repeating copyback process in the data transferring of discontinuous and tiny instruction sections. Moreover, the conventional USB utilities introduce flash memory as the storage device, therefore, most of the conventional USB utilities adopt the file system of FAT16 and FAT32. The FAT16 and FAT32 file system usually process information section in the discontinuous and tiny instruction form. In other situation, the FAT16 and FAT32 file system also use the instructions inserted among continuous instruction. That means, USB utilities of FAT16 and FAT32 file system will spend more time in copyback procedure. And the extra copyback procedure will elongate time spending in the reading and writing of the instruction and data section.

Therefore, it is the objective of the present invention to provide a method that can decrease the frequency of moving data into and from the flash, and optimize the operation order by rearranging the instructions according to a priority criterion, so that the efficiency of accessing the flash memory storage device can be enhanced.

### SUMMARY OF THE INVENTION

In order to solve the mentioned problem of copyback time waste in USB utilities, the present invention provide a new solution to effectively decrease the copyback time consumption of the writing and reading instructions. In present invention, the inventor divides the flash memory into two parts of cache memory and flash memory. The function of cache memory is to deposit instructions and data which are used frequently. By the employment of the cache memory, the instruction and data parts could be accessed directly without moving other unnecessary data sections, and less time is required to move the necessary data in accordance with the basic block unit in the flash memory. And the format of inputted instructions and data could be continuous, interrupted, repeated or distinct instruction section. Refer to the FIG. 3 and FIG. 4 of present invention, the instruction outputted by the computer is judged by the flash controller to determine either the instruction should be saved in a cache memory or in a flash memory. The flash controller 4 contains USB interface 2, flash bus interface, and flash manager as shown in FIG. 5. And the practices of the input and output of the instructions and data are the same with the conventional USB or flash reading and writing method. Basic constitution of the flash controller 4 includes parts of microprocessor control unit (MCU), software programs, and random access memory (RAM). By the selection of the flash controller according to a mapping table, the instructions and data could be saved in the part of cache memory, as a result, reducing the time consumption of the copyback procedure. The flash memory part, which is used for saving larger and distinctive instructions and data, can receive the instructions and data from the cache memory while the system is idle. The present invention is specifically with regard to the file system which divides instructions with discontinuous and tiny section, like FAT16 and FAT32, to reduce the writing and reading time by inputting reiterative instruction section into the cache memory, and avoiding the unnecessary copyback procedure. The elimination of the overlap copyback procedure can obviously improve the efficiency of the USB flash memory storage device.

A method of accessing to the flash memory storage device through universal serial bus (USB) is disclosed in the present invention. The main objective of the present invention is to improve the accessing efficiency of the storage device with flash memory. The time consumption for copyback operation is reduced by using a cache memory and an efficient flash controller. The cache memory is provided in the storage device and can be accessed by the flash controller of the storage device. The present invention provides a method to access the flash memory storage device through USB and the flash memory storage device including a flash controller and a flash memory. The method comprises:
(1) connecting a flash memory storage device to a USB interface connected with an electronic device;
(2) outputting plural accessing instructions to the flash controller of the flash memory storage device;
(3) deciding whether the accessing instructions to be temporarily saved in a cache memory or a flash memory by the algorithm methods and microprocessor control unit of the flash controller wherein the priority of the accessing instructions is determined according to the characteristic of a file system, and the accessing instructions moved to the cache memory will act as cached instructions, and the file system comprises a boot partition section, a file allocation table section, a root entry section, a file entry section and a database section; and
(4) executing the cached instructions according to the priority decided by the flash controller and writing the data temporarily saved in the cache memory into the flash memory when the cached instructions are no longer being used.

In order to achieve the purpose of USB storage device, all the data accessing and storing are operated under the configuration of common operation system (OS). All theses accessing and storing procedures will be transferred into individual instructions with the bottom layer of the operation system, and the instructions will be sent through the USB bus to the flash disk by the operating of computer as illustrated in FIG. 1. After these instructions are accepted by the flash controller in the USB interface, these instructions will be sent to the flash manager to do the optimal classifying via the microprocessor control unit (MCU) and other algorithm methods (programs). The focusing of the present invention is the optimal classifying of the MCU and the algorithm methods to select the instructions and data either enter to the cache memory or the flash memory. All the necessary algorithm methods are deposited in program ROM and program RAM and comply with other indispensable hardware structures to complete the whole flash controller functional block diagram like the illustration in FIG. 9.

### BRIEF DESCRIPTION OF THE DRAWINGS

Characteristics and advantage of the present invention will be more clearly understood by referring to accompanied drawings wherein:

FIG. 1 is a system view illustrating a method to access flash memory storage device through universal serial bus according to the present invention.

FIG. 2 is a view illustrating the file system according to the present invention can be realized.

FIG. 3 is a flow chart illustrating the method to access flash memory storage device through universal serial bus according to the present invention.

FIG. 4 is a flow chart illustrating another method to access storage device through universal serial bus according to the present invention.

FIG. 5 is the main framework of the relations between flash controller, flash memory, and USB interface according to the present invention.

FIG. 6 is an operating method of the present invention which contains identical instructions or repeated instructions and improves the whole writing process time from 66 seconds to 46 seconds.

FIG. 7 is an operating method of the present invention which contains continuous instructions and improves the whole writing process time from 66 seconds to 26 seconds.

FIG. 8 is an operating method of the present invention which contains reversed continuous instructions and improves the whole writing process time from 66 seconds to 26 seconds.

FIG. 9 is a functional block diagram of the flash controller according to the present invention.

### DESCRIPTION OF THE PREFERRED EMBODIMENTS

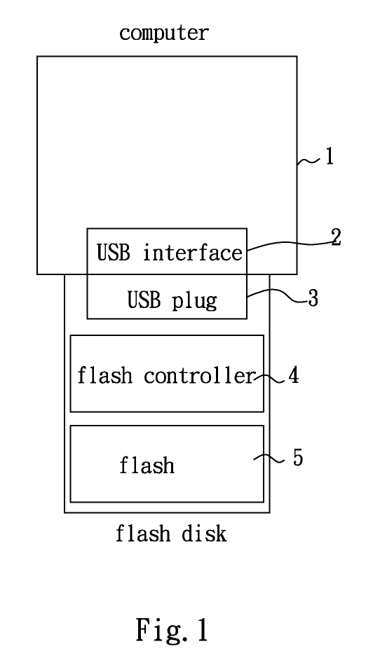

FIG. 1 is a system view illustrating a method of accessing to a flash memory storage device through universal serial bus according to the present invention. As shown in FIG. 1, in a method to access storage device through universal serial bus (USB). A flash 5 (flash memory) is utilized as the storage device in the present invention. The USB flash disk includes a flash controller 4 and a USB plug 3. The method of the present invention to access to the flash memory storage device through USB, comprises the USB plug 3 connected to a USB interface 2 of a computer 1. The computer 1 outputs an accessing (read/write) instruction to the flash controller 4, and the flash controller 4 determines whether the data contained in the accessing instruction is needed to be temporarily saved into the cache memory or not, and determines a priority of the accessing instruction according to a mapping table of a flash file system. Finally, the flash controller 4 executes the accessing instruction according to its priority, and writes the data temporarily saved in the cache memory into the flash memory.

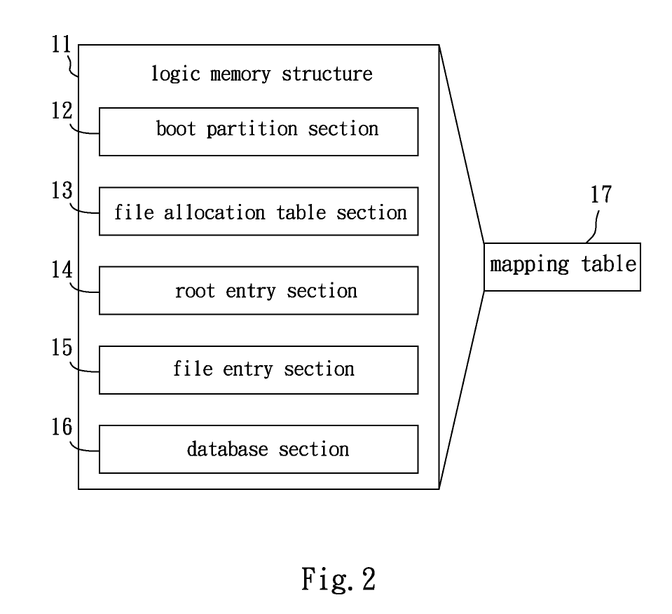

FIG. 2 is a view illustrating the logic memory structure 11 and a mapping table 17 based on which a method of accessing the flash memory storage device through USB of the present invention can be realized. As shown in FIG. 2, the mapping table 17 is a reference for the logic memory structure 11 in the flash file system. The flash file system in accordance with a logic memory structure 11 includes a boot partition section 12, a file allocation table section 13, a root entry section 14, a file entry section 15, a database section 16. The flash controller 4 will decide which data is needed to be saves in a cache memory and determine the priority sequence of the accessing instruction according to the mapping table 17 in the flash file system.

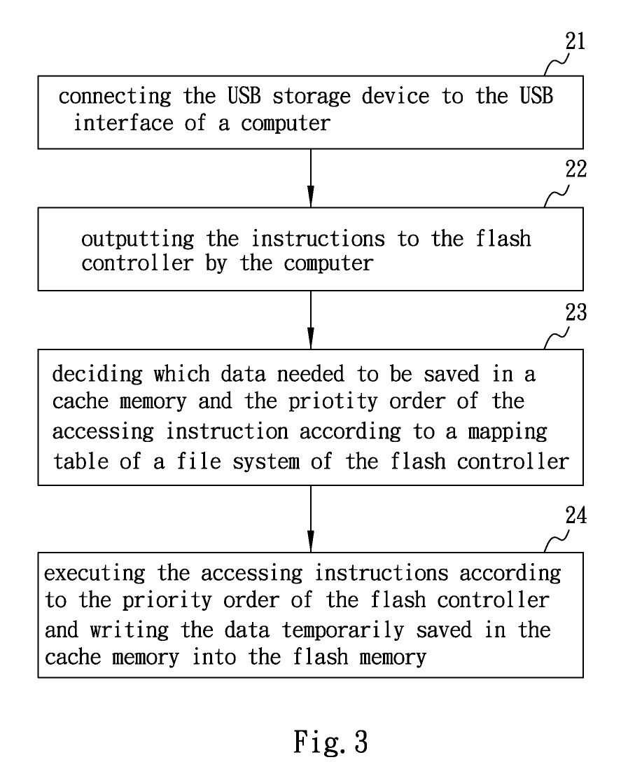

FIG. 3 is a flow chart illustrating an embodiment of a method to access storage device through USB according to the present invention. The method includes the following steps:

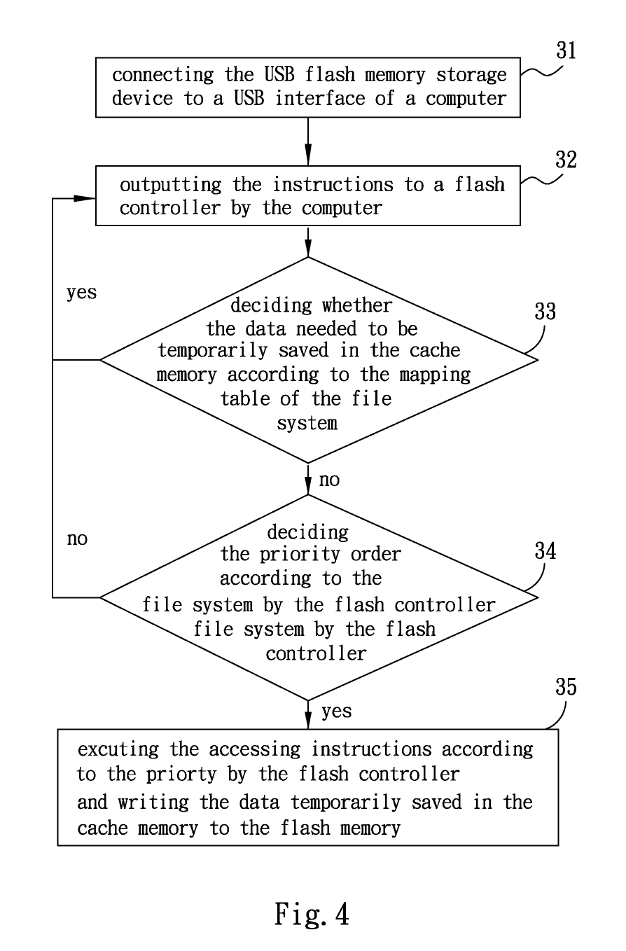

Step 21: connecting the USB device to the USB interface of a computer;
Step 22: outputting the accessing instructions to the flash controller 4 by the computer;
Step 23: deciding which data is needed to be saved in a cache memory by the flash controller 4, and determining the priority of the accessing instruction according to a mapping table of a flash file system, wherein the mapping table is a reference for the flash file system in accordance with a logic memory structure, and the flash file system in accordance with a logic memory structure including a boot partition section, a file allocation table section, a root entry section, a file entry section and a database section;
Step 24: executing the accessing instructions according to the priority by the flash controller 4 and writing the data temporarily saved in the cache memory into the flash memory.
FIG. 4 is a flow chart illustrating another embodiment of a method to access to the storage device through universal serial bus according to a preferred example of the present invention. The method includes the following steps:
Step 31: connecting the USB device to an USB interface of a computer;
Step 32: outputting the instructions to a flash controller 4 by the computer;
Step 33: deciding whether the data is needed to be temporarily saved in the cache memory according to the mapping table of the flash file system so that if some of the data is needed to be temporarily saved in the file entry section or the file entry section, returning to Step 32, otherwise, proceeding to the next step;
Step 34: deciding the priority according to the flash file system by the flash memory, if the instruction has a priority, proceeding to the next step, otherwise, returning to Step 32;
Step 35: executing the accessing instructions according to the priority by the flash controller 4 and writing the data temporarily saved in the cache memory into the flash memory.

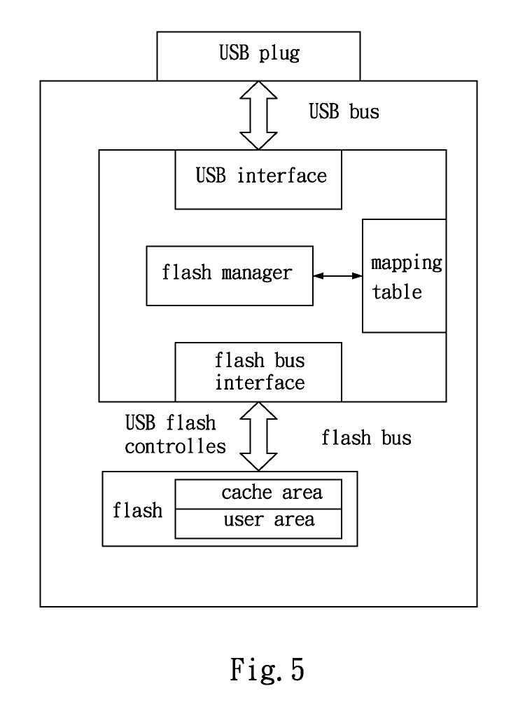

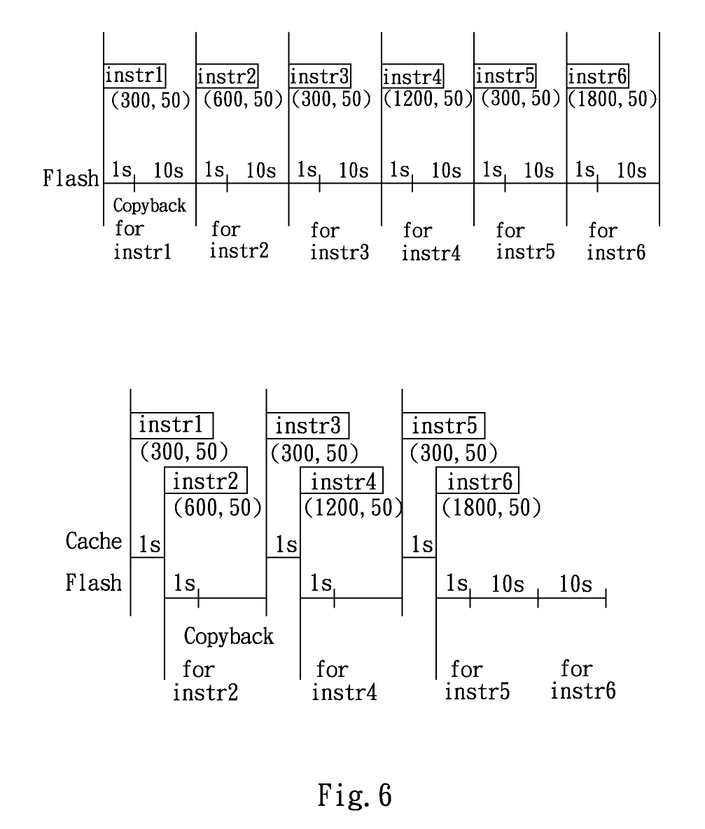

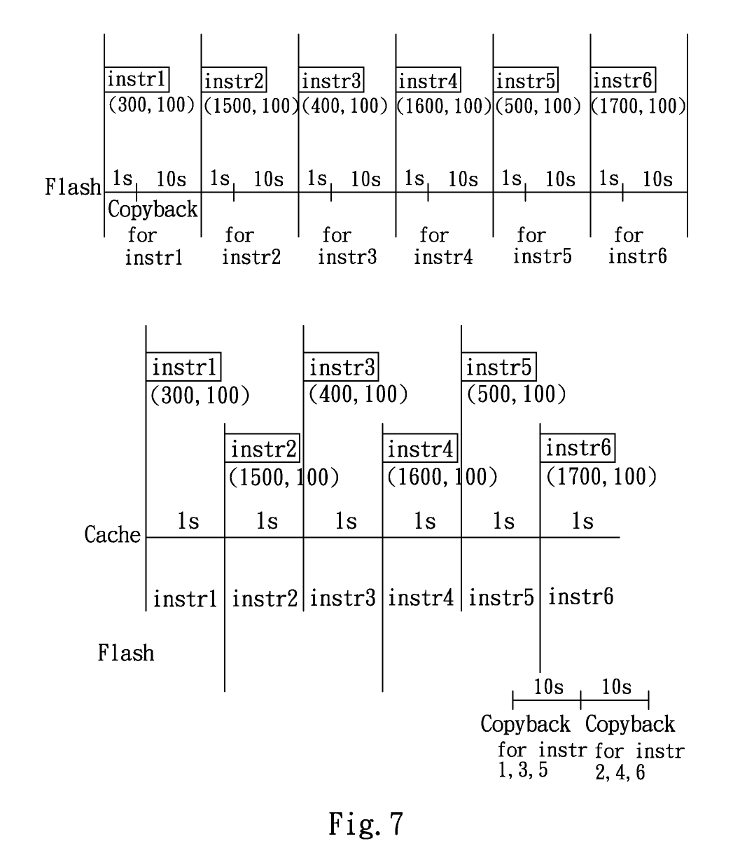

FIG. 6 is a comparison of the present invention and the prior art. The instructions transferred from computer 1 are sent to the flash controller 4 through the USB interface as shown in FIG. 5. After the instructions have been delivered to the flash controller 4, the instruction will be chosen to enter to the cache memory or flash memory based on the mapping table shown in FIG. 2. When the accessing instructions are decided to enter to the cache memory parts, the time saving advantage of the present invention, which is shown in the FIG. 6 and FIG. 7, could be apparently achieved. Referring to the FIG. 6, in the prior art, the instructions of the conventional method include the information of address, input length and other data parts. And all the instructions are written into the flash memory 5 in turn. As a result, in FIG. 6, the flash memory 5 needs repetitively writing the 10 s length copyback section into the flash memory during the instruction 1 to instruction 6 inputting period, wherein the (300, 50) of the instruction 1 states for the data address is 300 and the data length is 50 units. The total process will spend 66 seconds which include six copyback sections. But in the method of present invention, which is shown in FIG. 6, the flash memory which contains the cache memory that can reduce the repetitive parts of the instructions and save the time spending in the copyback process. In FIG. 6, while the first, third and fifth instructions are all identical instructions which usually happen in the FAT 16 and FAT 32 file system, the repetitive part of first, third, fifth instructions can be inputted only at the final part. As shown in the lower part of FIG. 6, the copyback process is only carried out at the last part of fifth instruction period. It is obvious that the time spending in the copyback processes of first and third instructions has been shortened. The total time spending in the whole writing process is improved from 66 seconds to 46 seconds. Thus, the USB storage device which contains the cache memory part of the present invention can markedly fast the reading and writing speed.

Another preferred example of the present invention is shown in FIG. 7. FIG. 7 indicates the differentiation between prior art and the present invention. In FIG. 7, the computer 1 sends six instructions to flash controller 4, and the 1st, 3rd, 5th instructions and 2nd, 4th, 6th instructions are continuous instructions respectively. In the conventional USB utility data saving process, all six instructions have repeated in the copyback process due to the basic block unit limitation in the flash memory using USB storage device. But in the present invention, the conventional flash memory is divided into the two parts of the cache memory and the flash memory, and the cache memory which has no limitation of the basic block unit. As shown in FIG. 7, unlike the prior art which inputs all instructions into the flash memory, the present invention inputs all continuous instructions into the cache memory to reduce the unnecessary repeating of copyback processes in the flash memory. The 1st, 3rd, 5th instructions input all essential parts into the cache memory, and leave the copyback process in the flash memory. The same operation has been acted in the situation of 2nd, 4th, 6th continuous instructions. By the selection of the flash controller 4, the essential parts of instructions have been recorded in the cache memory which is able to exchange rapidly, and the copyback processes have been acted by the flash memory. The total process will spend 26 seconds which include six copyback sections. All the instructions and data stored at the cache memory will be transferred to the flash memory while the system is idle thereafter.

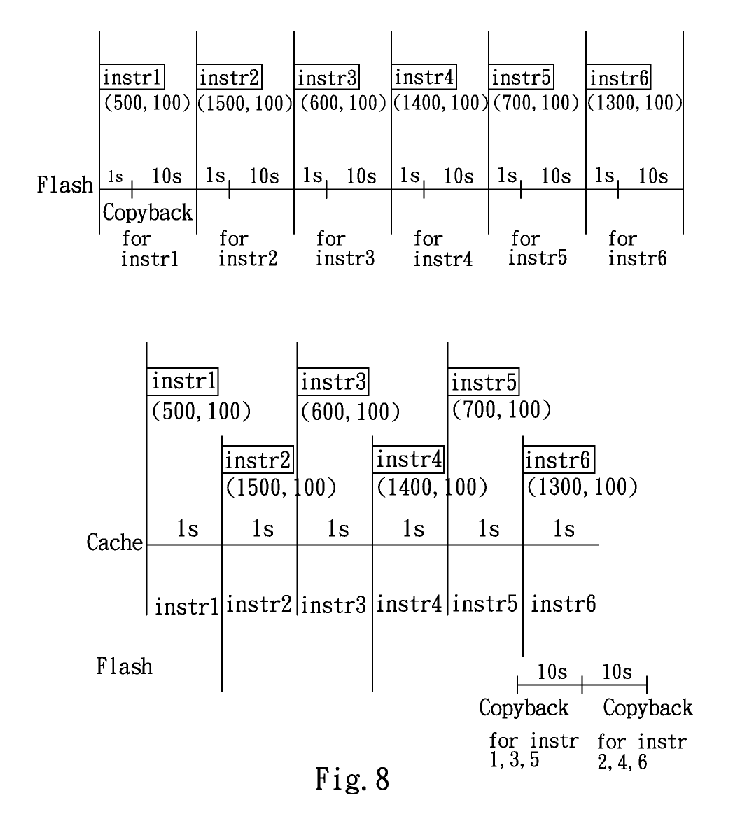

The FIG. 8 indicates another preferred example of the present invention, wherein the differentiation between the prior art and the present invention is illustrated In the preferred example of FIG. 8, the computer 1 sends six instructions to the flash controller 4, and the 1st, 3rd, 5th instructions are continuous instructions, but the 2nd, 4th, 6th instructions are reversed continuous instructions. For an example, the addresses of 2nd, 4th, 6th instructions are 1500, 1400, and 1300 which are different from the ordinary continuous instructions. In the conventional USB utility data saving process, all six instructions are repeatedly the copyback process due to the basic block unit limitation in the flash memory using USB storage device. But in the present invention, the conventional flash memory is divided into the two parts of the cache memory and the flash memory, and the cache memory which has no limitation of the basic block unit. As shown in FIG. 8, unlike the prior art which inputs all instructions into the flash memory, the present invention inputs all reversed continuous instructions into the cache memory to reduce the unnecessary repeating of copyback processes in the flash memory. The 1st, 3rd, 5th instructions input all essential parts into cache memory, and leave the copyback process in the flash memory. And the same operation is acted in the situation of 2nd, 4th, 6th reversed continuous instructions. By the selection of the flash controller 4, the essential parts of instructions are recorded in the cache memory which can exchange rapidly, and the copyback processes are carried by the flash memory. All the instructions and data stored at the cache memory will be transferred to the flash memory while the system is idle thereafter.

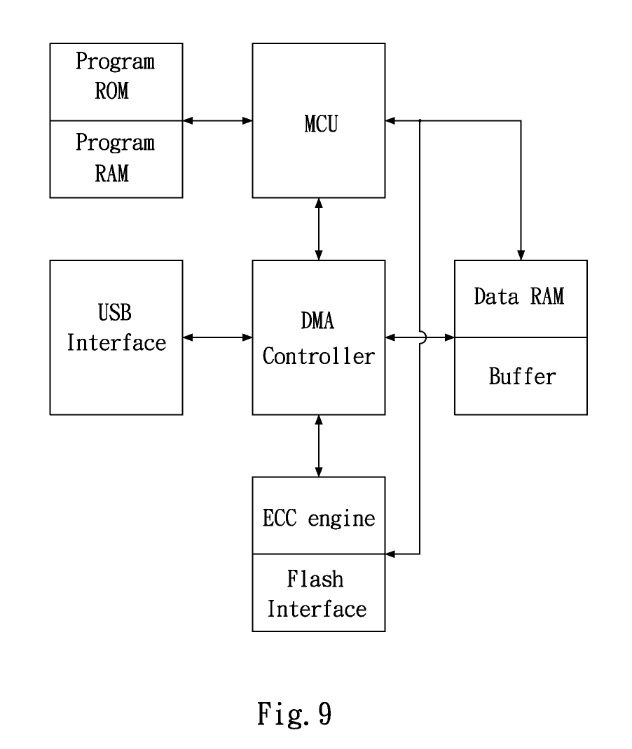

Referring to the FIG. 9, the FIG. 9 is the functional block diagram of the flash controller according to the present invention. Program ROM and program RAM are the algorithm deposition place and all the necessary operating instructions are processed by the microprocessor control unit (MCU). Besides, the data RAM is used for the saving of the mapping table and other necessary information for determination. In the process of the flash controller operating, the flash controller will receive all the instructions and data from the USB interface at first. And the algorithm deposited in program ROM and program RAM will move the instructions and data to the flash memory or the cache memory, which is relied on the content of instruction, the characteristic of the file system, the cache memory status, and the prior received instruction to determine either move to the flash memory or the cache memory. After the algorithm determined the moving target place of the aforementioned instructions and data, the DMA controller will execute the moving plan of the instructions and data to move them between the USB interface, the flash interface and the buffer zone. And the error-correcting code engine (ECC-engine) acts as the flash memory data error correction mechanism.

The algorithm method of the present invention is optimally reduced the times of copyback process by considering present and prior instruction address, data length, and the characteristics of the file system. For example, refer to the file system of the FIG. 2. the file system contains five parts, wherein the file allocation table section 13, the root entry section 14, and the file entry section 15 usually have the same specifics of similar instruction address, less data length, and higher repetition. When the algorithm method determines the writing or reading instructions belong to the aforementioned three types of instructions, the writing or reading instructions will be moved into cache memory with a higher priority. Besides, the writing or reading instructions of the database section 16 usually have the characteristics of mass data length and the continuous instruction address. In the situation, the algorithm method will provide a higher priority to the continuous instructions like the instructions of the database section 16. Besides, the priority of the instructions could be arranged in response to the different system demand or software application. By using the method of the present invention, the times of the copyback process could be reduced effectively.

According to the description above, it is clear that the method can be used to access storage devices via the USB. Because the data do not need to be repeatedly moved into and from the flash memory, and the priority of the accessing instructions can be determined while controlling the data and the instruction access. So the efficiency of accessing data can be improved by the method of the present invention. In the method of the present invention, the frequency of moving data into and from the flash can be decreased and the priority of the accessing instructions can be appropriately determined to optimize the efficiency of accessing the storage device.

While the present invention is illustrated by the preferred embodiments thereof, it will be understood by those skilled in the art that various changes in form and details may be effected therein without departing from the spirit and scope of the present invention as defined by the appended claims.

What is claimed is:

1. A method of accessing to a flash memory storage device through universal serial bus (USB), and the method comprising the steps of:
(1) connecting the flash memory storage device to a USB interface connected with an electronic device;
(2) outputting plural accessing instructions to a flash controller of the flash memory storage device;
(3) deciding whether the accessing instructions to be temporarily saved in a cache memory or a flash memory by the algorithm methods and a microprocessor control unit of the flash controller, wherein the priority of the accessing instructions is determined according to the characteristic of a file system, and the accessing instructions moved to the cache memory will act as cached instructions, and the file system comprises a boot partition section, a file allocation table section, a root entry section, a file entry section and a database section; and
(4) executing the cached instructions according to the priority decided by the flash controller and writing the data temporarily saved in the cache memory into the flash memory when the cached instructions are no longer being used.

2. The method of claim 1, wherein the flash controller comprise a program ROM, a program RAM, a microprocessor control unit, a USB interface, a DMA controller, a data RAM and buffer, a flash interface and a error-correcting code engine.

3. The method of claim 2, wherein the algorithm methods are deposited in the said program ROM and program RAM.

4. The method of claim 2, wherein the accessing instructions could be continuous instructions, interrupted instructions, reversed continuous instructions, repeated instructions or distinct instructions.

5. The method of claim 2, wherein the copyback section of the accessing instructions will be reduced to the minimum length.
